(19) United States
(12) Patent Application Publication
(10) Pub. No.: US 2002/0056121 A1
(43) Pub. Date: May 9, 2002

(54) Method and system for synchronizing content

(76) Inventor: Michael Ledbetter, Richmond, CA (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 09/783,210

(22) Filed: Feb. 14, 2001

Related U.S. Application Data
(60) Provisional application No. 60/182,337, filed on Feb. 14, 2000.

(51) Int. Cl. H04N 7/173

(52) U.S. Cl. 725/87

(57) ABSTRACT

A system and system of synchronizing a delivery of a first content to a plurality of users including providing a second content to a compression device to provide a time window in the second content, and delivering the first content to the plurality of users when the first content is synchronized to simultaneously deliver the first content to each of the plurality of users.

This application claims priority under 35 U.S.C. § 120 to U.S. Provisional application Ser. No. 06/182,337 entitled “Method And System For Synchronizing Content” filed on Feb. 14, 2000.

### BACKGROUND OF THE INVENTION

1. Technical Field of the Invention

The present invention generally relates to broadcasting of content, and more particularly, to a method and system of synchronizing the content to view or listen to the content across a number of broadcast channels at the same time.

2. Background of the Art

In the past, advertisers providing national advertisements to viewing audiences over televisions would typically have to schedule their advertising time with a particular broadcast station. This type of scheduling was problematic for several reasons. First, an advertiser had to schedule the advertising commercial months in advance of the showing of the advertisement commercial. Also, aside from the scheduling problems, advertisers were locked into paying for the advertising time months in advance of the airing of the advertising commercial at a time when the true value of the advertising time may change. Second, the broadcast station does not have any flexibility to rearrange or reschedule advertising commercial time during a particular show (e.g., sporting event, sitcom, movie, etc.) because it has contractually sold the particular air time for the commercial months in advance. This same lack of flexibility also occurs from the advertisers standpoint since the advertiser again cannot change or remove the air time.

Another problem associated with prescheduled television air time for commercials is that an advertiser may not be reaching the broadest viewing audience possible. In the past, an advertiser could estimate the viewing audience based on a standard estimator for ratings during a show, such as the well known Nielsen ratings. However, these estimators was typically inaccurate because the target viewing audience may change the channel during the advertising commercial and such estimators therefore are generally not accurate. Another reason these estimators are inaccurate is because most viewers or listeners will not view the advertisement on the television or listen to the advertisement on the radio but rather will move to another station providing a show that is not advertisement.

Thus, a need exists to be able to reach your advertisement to all viewers without the possibility of the viewer changing the content. In essence, leaving the viewer or listener with only one alternative of turning off the television or audio receiver or otherwise viewing the content on a multiple of broadcast channels. Furthermore, a need exists to simultaneously send that advertisement to all stations so that all audiences will be insured of viewing the advertisement regardless of whether or not the viewer or listener changes a channel.

A still further need in the industry is the flexibility to schedule an advertisement during a show at the last minute. That is, instead of prescheduling advertisements months ahead of time, advertisers wish to be able to schedule an advertisement at a last available moment and broadcasters would be willing to sell that time at a last minute for a premium charge.

Additionally, a tremendous need exists to compress shows during a time period to create more time for advertising commercials and accordingly additional revenues for the broadcasters. A need also exists to be able to add the additional advertising time at any portion of the show. That is, if, for example, an additional two minutes of advertising commercial time is created by compressing the show, a need exists to be able to control the particular two minutes across a number of channels so that the particular advertisement may be simultaneously viewed at the same time throughout various channels. By doing this, that advertisement is sent at the same time to all viewers across all channels which increases and captures the target audience since no alternatives are left but to view the advertisement.

A product known as the Time Machine® manufactured by Prime Image, Inc. of San Jose, Calif., has been used in the past to compress shows to create additional time for advertising commercials. However, that Time Machine® has not been used to synchronize content among a plurality of viewers so that to alleviate the problems described above.

A need therefore exists for a method and system of providing a simultaneous advertisement to all viewers across all channels at the exact same time and the flexibility to do that even at the last moment.

### SUMMARY OF THE INVENTION

The present invention provides for a method of synchronizing a delivery of a first content to a plurality of users that includes providing a second content to a compression device that compresses the first content to provide a time window in the second content where the compression device is capable of having a processing device for controlling the synchronization of the time window. Then delivering the first content to the plurality of users at the time window when the first content is synchronized to simultaneously deliver the first content to each of the plurality of users.

In a further embodiment, a method of synchronizing a first content to the users is provided by providing the first content to a distributing device, distributing the first content to a compression device that compresses the first content to provide a time window in a second content, the compression device being capable of having a processing device for controlling the synchronization of the time window. Then, synchronizing the first content to simultaneously deliver the first content to a user at the time window.

In a still further embodiment, a system is provided for synchronizing a first content to a user that includes a first content providing device for providing a first content to a plurality of users, a second content providing device for providing a second content to the plurality of users and a compression device for compressing the second content to create a time window for providing the first content to the time window to the plurality of users.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a block diagram view of an embodiment of the system of the present invention; and

FIG. 2 is a block diagram view of a further embodiment of the system of the present invention.

### DETAILED DESCRIPTION OF THE PREFERRED EMBODIMENTS

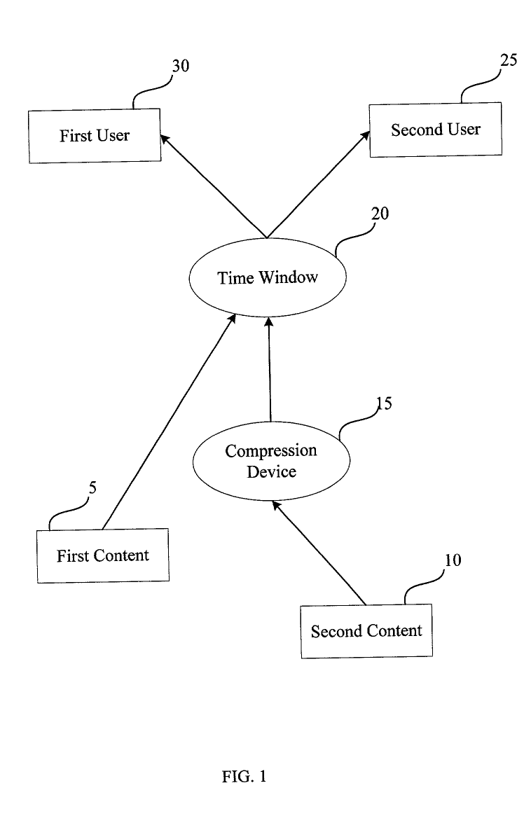

FIG. 1 is a block diagram view of an embodiment of the system of the present invention. In FIG. 1, a first content 5 and second content 10 are provided to a first 30 and second 25 users. The first content 5, in this embodiment, is an advertisement that is to be viewed during a second content 10, which is generally a sitcom, sporting event, movie, news, or the like. Thus, the first content 5 is advertisement that is scheduled to be viewed during commercial breaks of the second content 10. It is noted that the first 5 and second 10 content is generally viewed on a television, computer or other displaying device that is capable of displaying content to a user. The second content 10 is sent to a compression device 15, such as the Time Machine® manufactured by Prime Image, Inc. of San Jose, Calif. That product generally takes the second content 10, such as a sporting event, movie, sitcom, news, etc., and compresses the amount of time of the particular second content 10 in order to create more time for the first content 5, e.g., advertising commercials. The benefit of this compression device is clear. By compressing the second content to create an additional time window 20, more first content 5, e.g., advertising commercials, may be included in a second content 10 to increase advertising revenue for the broadcaster. An additional benefit is that the time window 20 created may create a flexible time window 20 in the second content 10 that will permit a broadcaster to synchronize a particular first content 5 to be viewed simultaneously across a number of broadcasting channels. This is a tremendous benefit never available in the past. By creating the time window 20 in the second content 10, for example an additional two minute time window, a broadcaster may create an additional two minutes of space to synchronize a particular first content 5 to be viewed simultaneously across a number of broadcast channels. That is, once the two minutes of additional time is created among a number of broadcast channels, an advertiser may schedule his advertisement (first content 5) to be viewed at the same two minute time window across a number of broadcast channels. By doing this, a viewer or listener (user) is forced to view the advertisement even if the user changes the channel.

The system of this embodiment requires only that each second content 10 be sent to a compression device 15, such as the Time Machine® of Prime Image, Inc., to create the additional time window in the second content where the first content 5 will be placed. Then the first content 5 is synchronized to be sent to the first user 30 and the second user 25 simultaneously. Note that while two users are shown in the embodiment of FIG. 1, more than two users may be sent the first 5 and second 10 content. In fact, a plurality of users (at least two users) are capable of receiving the synchronized first content 5 within the time window 20 created by the compression device 15 within the second content 10. At least two users are needed since it is those two users that are simultaneously receiving the first and second content. It is further noted that the user may be a viewer, in one embodiment, and a listener, in another embodiment. If audio signals are being compressed rather than visual signals, another product, also manufactured by Prime Image, Inc. and known as the Cash Machine, may be used to compress the audio signals.

In use, the delivery of the first content 5 to a plurality of users 30, 25 is as follows. The second content 10 is provided to the compression device 15 where the second content 10, e.g., the movie, sitcom, news, audio talk show, is compressed to create the time window 20. The first content 5, e.g., the advertisement, is then sent to the time window 20 and placed in the time window that is simultaneously delivered to the plurality of users 30, 25. In a further embodiment, the system contains a processor as part of the compression device that is used to control the timing of the time window containing the first content 5. By doing this, the first content 20 may be synchronized to be shown or listened to by the plurality of users at the same time. This advantage is clear in that all of the first content 5 is shown at the same time (synchronized) across a number of broadcast channels so as to capture the viewing or listening audience.

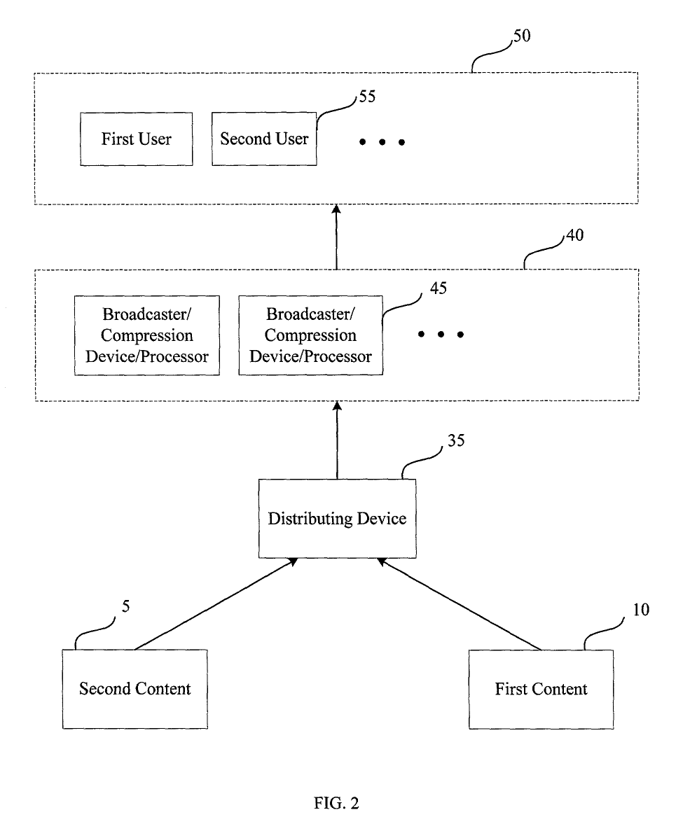

FIG. 2 is a block diagram view of a further embodiment of the system of the present invention. In FIG. 2, the same first 10 and second 5 content of FIG. 1 are shown being transmitted to a distributing device 35. The distributing device 35 may be, in one embodiment, a satellite transmitter or other type of transmitter that is capable of transmitting the first and second content to a broadcaster/compression device/processor 45. Again, much like in FIG. 1, the first and second content is transmitted to a compression device 45 that is, in this embodiment, maintained by the broadcaster 45 and that has a processor 45 so as to time the simultaneous broadcast of the first and second content through the newly created time window (not shown). The synchronized first content is then sent to the plurality of users 50 for simultaneous viewing by all users of the same first content 5, e.g., advertisement.

Again, the embodiment of FIG. 2, much like FIG. 1, advantageously allows the first content 5 to be synchronized by the processor to be simultaneously viewed or listened by all the plurality of users to that the advertisement (first content) cannot be avoided by the viewer or listener. Thus, the entire audience is captured since changing the broadcast channel will not avoid viewing the advertisement since all advertisements may be simultaneously sent to all users at the same time.

Other embodiments may be readily apparent to one skilled in the art to which this invention pertains that fall within the scope of the invention as claimed below.

What is claimed is:

1. A method of synchronizing delivery of a first content to a plurality of users, comprising the steps of:
providing a second content to a compression device for compressing said second content to provide a time window in said second content, said compression device having a processing device for controlling said synchronizing of said time window; and
delivering the first content to the plurality of users at said time window when the first content is synchronized to simultaneously deliver said first content to each of the plurality of users.

2. A method of delivering a first content to a plurality of users, comprising the steps of:
compressing a second content associated with a second content time window with a compression device, to provide a first content time window in said second content time window for insertion of the first content therein; and
synchronizing with a processor the first content with said second content in said second content time window for delivery to the plurality of users.

3. The method of claim 2, wherein the first content is one or more advertisements which can be viewed during corresponding commercial breaks of said second content.

4. The method of claim 3, wherein said second content in the step of compressing is a sitcom, a sporting event, a movie, or a news broadcast.

5. The method of claim 2, wherein the first content in the step of synchronizing is synchronized across one or more broadcasting channels.

6. The method of claim 5, wherein the first content in the step of synchronizing is synchronized simultaneously across one or more broadcasting channels.

7. The method of claim 2, wherein only said second content is compressed with said compression device in the step of compressing.

8. The method of claim 2, wherein the plurality of users which receive the first content can be presented with the first content both visually and aurally.

9. The method of claim 2, wherein a first user of the plurality of users can receive the first content visually, and a second user of the plurality of users can receive the first content aurally.

10. The method of claim 2, wherein the compression device in the step of compressing compresses both visual and audio content of said second content.

11. The method of claim 2, further comprising the step of distributing with a distributing device the first content and said second content to said compression device.

12. The method of claim 11, wherein said distributing device is a satellite transmission system.

13. The method of claim 2, wherein said compression device in the step of compressing comprises said processor for timing of a broadcast of the first content and said second content.

14. A system of delivery of a first content to a plurality of users, comprising:
a second content associated with a second content time window which is compressed with a compression device, to provide a first content time window in said second content time window for insertion of the first content therein; and
a processor which synchronizes the first content with said second content in said second content time window for delivery to the plurality of users.

15. The system of claim 14, wherein the first content is one or more advertisements which can be viewed during corresponding commercial breaks of said second content.

16. The system of claim 15, wherein said second content is a sitcom, a sporting event, a movie, or a news broadcast.

17. The system of claim 14, wherein the first content is synchronized across one or more broadcasting channels.

18. The system of claim 17, wherein the first content is synchronized simultaneously across one or more broadcasting channels.

19. The system of claim 14, wherein only said second content is compressed with said compression device.

20. The system of claim 14, wherein the plurality of users which receive the first content are presented with the first content both visually and aurally.

21. The system of claim 14, wherein a first user of the plurality of users receives the first content visually, and a second user of the plurality of users receives the first content aurally.

22. The system of claim 14, wherein the compression device compresses both visual and audio content of said second content.

23. The system of claim 14, wherein a distributing device distributes the first content and said second content to said compression device.

24. The system of claim 23, wherein said distributing device is a satellite transmission system.

25. The system of claim 14, wherein said compression device comprises said processor for timing of a broadcast of the first content and said second content.

26. A system for synchronizing a first content to a user, comprising:
a first content providing device for providing a first content to a plurality of users;
a second content providing device for providing a second content to said plurality of users; and
a compression device for compressing said second content to create a time window for providing said first content in said time window to said plurality of users.

27. A method of synchronizing a first content to a user, comprising the steps of:
providing the first content to a distributing device;
distributing the first content to a compression device for compressing the first content to provide a time window in a second content, said compression device having a processing device for controlling the synchronizing of said time window; and
synchronizing the first content to simultaneously deliver the first content to the user at said time window.
